(19) United States
(12) Patent Application Publication
(10) Pub. No.: US 2011/0139574 A1
(43) Pub. Date: Jun. 16, 2011

(54) BANKNOTE HANDLING SYSTEM AND BANKNOTE HANDLING METHOD

(76) Inventors: Shoji Tomiya, Chiba-ken (JP); Noboru Taguchi, Chiba-Ken (JP)

(21) Appl. No.: 12/737,831

(22) PCT Filed: Aug. 20, 2008
(86) PCT No.: PCT/JP2008/064820

§ 371 Date: Feb. 18, 2011

(51) Int. Cl. G07D 7/00

(52) U.S. Cl. 194/302

(57) ABSTRACT

There is provided a banknote handling system capable of improving an efficiency of a recognition and count process, by transporting a paper sheet to be recounted and a paper sheet not to be recounted to separate reject units. The banknote handling system includes at least one stacking unit and first and second reject units. The banknote handling system includes: a reception unit configured to receive a paper sheet; a first judgment unit configured to judge whether the paper sheet received by the reception unit is a predetermined banknote or not; a second judgment unit configured to judge whether the paper sheet that has not been judged as the predetermined banknote by the first judgment unit is a dissimilar banknote or not; a transport unit configured to transport the paper sheet received by the reception unit to the stacking unit, the first reject unit, or the second reject unit; and a control unit configured to control the transport unit such that: the paper sheet which has been judged as the predetermined banknote by the first judgment unit, is transported to the stacking unit; that the paper sheet which has been judged as the dissimilar banknote by the second judgment unit, is transported to the first reject unit; and that the paper sheet which has not been judged as the dissimilar banknote by the second judgment unit, is transported to the second reject unit.

### FIELD OF THE INVENTION

The present invention relates to a banknote handling system and a banknote handling method. In particular, the present invention relates to a banknote handling system and a banknote handling method used for a recognition and count process of banknotes.

### BACKGROUND ART

As a banknote handling system used for a recognition and count process of banknotes, a banknote handling system including a stacking unit and a reject unit is known. The banknote handling system is configured to transport banknotes, which have been normally recognized and counted, and have a predetermined property (such as counterfeit note, denomination, face-up/face-down or orientation), to the stacking unit, as well as to transport banknotes, which have not been normally recognized and counted, or do not have the predetermined property, to the reject unit.

As such a banknote handling system, a banknote processing machine disclosed in JP2000-259895A is known, for example. The banknote processing machine includes a plurality of stacking units and one reject unit. The banknote processing machine is configured to recognize denomination of banknotes having been put into a reception unit, and to transport the banknotes to the plurality of stacking units respectively by denomination of the banknotes. In addition, the banknote processing machine is configured to transport, to the reject unit, a banknote among the banknotes having been put into the reception unit, which falls under a preset reject reason (e.g., an abnormally recognized note, an abnormally transported note, a counterfeit note, a note of undesignated denomination, and a face-down note of designated denomination). In this type of banknote processing machine, there is a possibility that a banknote to be recounted (e.g., a face-down note of designated denomination) and a banknote not to be recounted (e.g., a counterfeit note) might be accommodated in the same reject unit in a mixed manner. In such a case, an operator recounts all the banknotes having been transported to the reject unit, or extracts only the banknotes to be recounted from the banknotes having been transported to the reject unit, and recounts the same.

Herein, if all the banknotes having been transported to the reject unit are recounted by the banknote processing machine, not only the banknotes to be recounted but also the banknotes not to be recounted are subjected to the recognition process. On the other hand, in the banknote processing machine, when only the banknotes to be recounted are extracted from the banknotes having been transported to the reject unit, such an extracting operation is manually performed by the operator. Thus, as the number of banknotes having been transported to the reject unit increases, an efficiency of the recognition and count process is impaired.

Particularly when the number of the stacking units is small, when the number of the preset reject reasons is large, and/or when paper sheets (e.g., blank sheets, coupons, and barcode tickets) other than banknotes are recognized together with the banknotes, the number of paper sheets to be transported to the reject unit increases, so that the efficiency of the recognition and count process is further impaired.

Namely, the conventional banknote handling system has a problem in that, since banknotes to be recounted and banknotes not to be recounted are accommodated in the same reject unit in a mixed manner, the efficiency of the recognition and count process is impaired.

### DISCLOSURE OF THE INVENTION

The present invention has been made in view of the above circumstances. According to the present invention, since banknotes to be recounted and banknotes not to be recounted are transported to separate reject units, the efficiency of the recognition and count process can be enhanced.

According to the present invention, there is provided a banknote handling system including at least one stacking unit and first and second reject units, the banknote handling system including: a reception unit configured to receive a paper sheet; a first judgment unit configured to judge whether the paper sheet received by the reception unit is a predetermined banknote or not; a second judgment unit configured to judge whether the paper sheet that has not been judged as the predetermined banknote by the first judgment unit is a dissimilar banknote or not; a transport unit configured to transport the paper sheet received by the reception unit to the stacking unit, the first reject unit, or the second reject unit; and a control unit configured to control the transport unit such that: the paper sheet which has been judged as the predetermined banknote by the first judgment unit, is transported to the stacking unit; that the paper sheet which has been judged as the dissimilar banknote by the second judgment unit, is transported to the first reject unit; and that the paper sheet which has not been judged as the dissimilar banknote by the second judgment unit, is transported to the second reject unit.

In the present invention, it is preferable that, when at least one judgment parameter among a plurality of judgment parameters of the paper sheet is a dissimilar parameter, the second judgment unit judges the paper sheet as a dissimilar banknote.

In the present invention, it is preferable that the second judgment unit performs the judgment process based on magnetic information of the paper sheet.

In the present invention, it is preferable that the second judgment unit performs the judgment process based on a black and white ratio of the paper sheet.

In the present invention, it is preferable that the second judgment unit performs the judgment process based on a size of the paper sheet.

In the present invention, it is preferable that the second judgment unit performs the judgment process based on the number or a ratio of dissimilar parameters among a plurality of judgment parameters.

In the present invention, it is preferable that the first judgment unit further judges whether the paper sheet is abnormally transported or not, and that the control unit controls the transport unit such that the paper sheet which has been judged as an abnormally transported banknote by the first judgment unit, is transported to the second reject unit.

In the present invention, it is preferable that the first judgment unit further judges whether the paper sheet is a counterfeit note or not, and that the control unit controls the transport unit such that the paper sheet which has been judged as a counterfeit note, is transported to the first reject unit.

In the present invention, it is preferable that the second judgment unit judges a paper sheet not to be recounted as the dissimilar banknote.

In the present invention, it is preferable that the banknote handling system further includes a storage unit configured to store a judgment standard, and a detection unit configured to detect a feature of the paper sheet, wherein, when a detection result of the detection unit deviates from a predetermined scope relative to the judgment standard stored in the storage unit, the second judgment unit judges the paper sheet as the dissimilar banknote.

According to the present invention, there is provided a banknote handling method including: a reception step of receiving a paper sheet; a first judgment step of judging whether the paper sheet received in the reception step is a predetermined banknote or not; a second judgment step of judging whether the paper sheet that has not been judged as the predetermined banknote in the first judgment step, is a dissimilar banknote or not; and a transport step in which the paper sheet that has been judged as the predetermined banknote in the first judgment step, the paper sheet that has been judged as the dissimilar banknote in the second judgment step, and the paper sheet that has not been judged as the dissimilar banknote in the second judgment step, are sorted and transported.

### BRIEF DESCRIPTION OF THE DRAWINGS

FIG. 1 is a perspective view showing an appearance of a banknote handling system 100 in an embodiment according to the present invention;

FIG. 2 is a block view showing a control block of the banknote handling system 100 in the embodiment according to the present invention;

FIG. 3 is a schematic view showing a data structure of a judgment standard 110B in the embodiment according to the present invention;

FIG. 4 is a flowchart showing a process procedure of a deposit process in the embodiment according to the present invention;

FIG. 5 is a flowchart showing a process procedure of a judgment process (S403) in the embodiment according to the present invention;

FIG. 6 is a schematic view showing a data structure of a judgment standard 110b in an alternative example 1 of the embodiment according to the present invention;

FIG. 7 is a flowchart showing a process procedure of a judgment process in the alternative example 1 of the embodiment according to the present invention;

FIG. 8 is a schematic view showing a data structure of a judgment standard 110B in an alternative example 2 of the embodiment according to the present invention; and

FIG. 9 is a flowchart showing a process procedure of a judgment process (S203) in the alternative example 2 of the embodiment according to the present invention.

### BEST MODE FOR CARRYING OUT THE INVENTION

An embodiment according to the present invention will be described herebelow with reference to the drawings. The following embodiment is a mere example of the present invention, and thus does not limit the scope of the present invention.

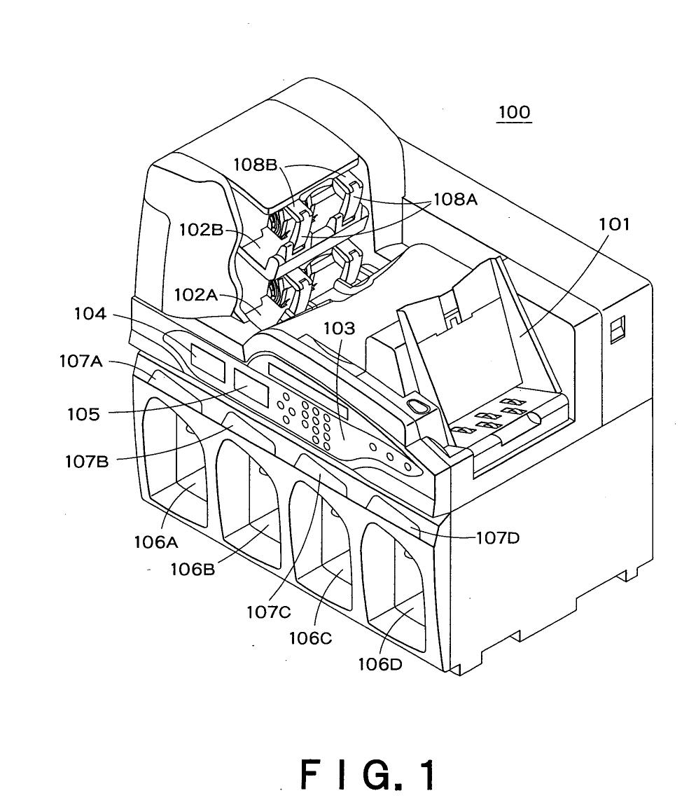

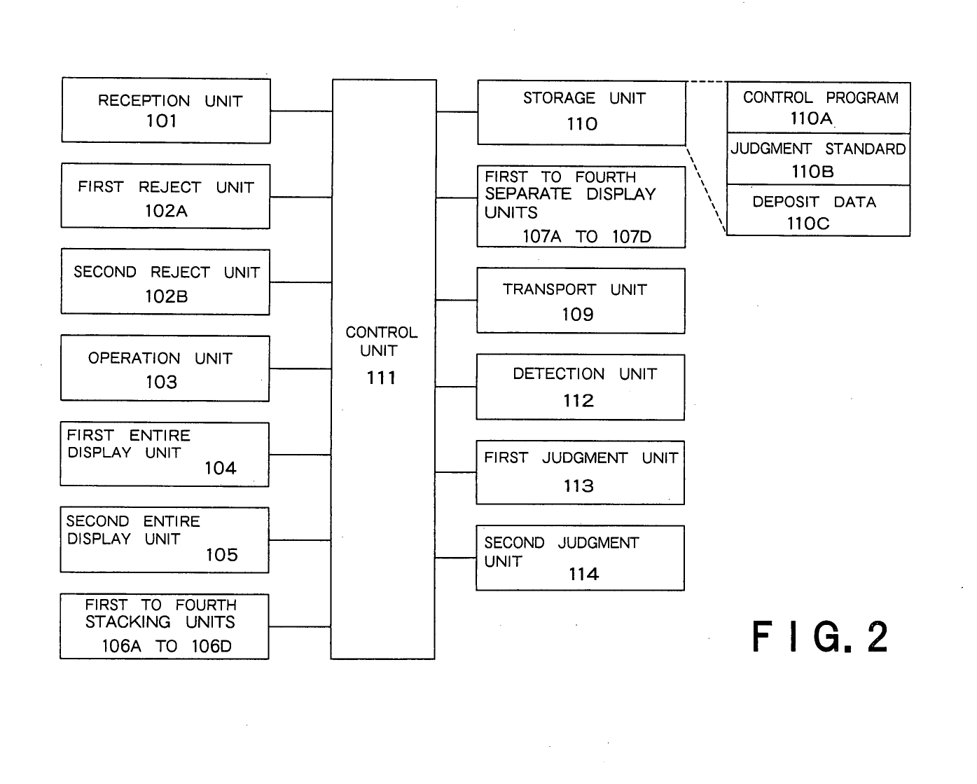

At first, the structure of a banknote handling system 100 is described with reference to FIGS. 1 and 2.

FIG. 1 is a perspective view showing an appearance of the banknote handling system 100 in the embodiment according to the present invention. FIG. 2 is a block view showing a control block of the banknote handling system 100 in the embodiment according to the present invention.

As shown in FIG. 1, the banknote handling system 100 includes a reception unit 101, first and second reject units 102A and 102B, an operation unit 103, first and second entire display units 104 and 105, first to fourth stacking units 106A to 106D, and first to fourth separate display units 107A to 107D. As shown in FIG. 2, the banknote handling system 100 further includes a storage unit 110, a control unit 111, a detection unit 112, and first and second judgment units 113 and 114.

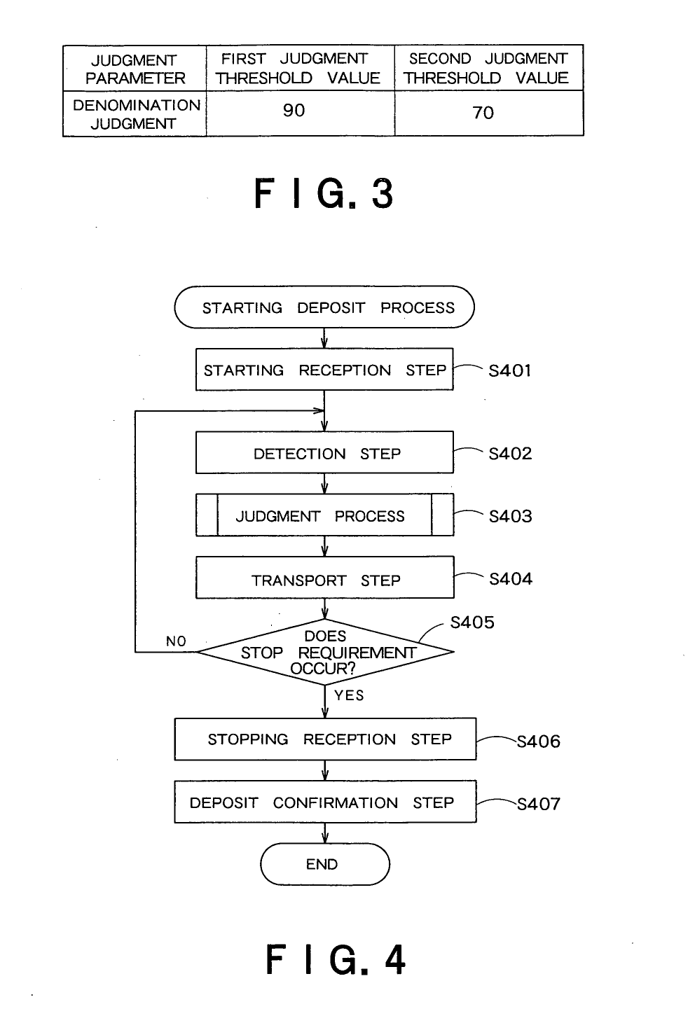

The storage unit 110 is configured to store a control program 110A for the control unit 111, a judgment standard 1106 (see, FIG. 3) for the first and second judgment units 113 and 114, and deposit data 110C. In addition, the storage unit 110 serves as a working memory of the control unit 111.

As shown in FIG. 3, the judgment standard 1106 is composed of a first judgment threshold value and a second judgment threshold value that are relevant to a denomination judgment. The first judgment threshold value is a threshold value for recognizing a denomination of a banknote, which is to be subjected to a recognition and count process mode that has been previously received by the operation unit 103, and provides data to be referred to by the first judgment unit 113. The second judgment threshold value is a threshold value for judging that a paper sheet is similar to a banknote (hereinafter referred to as “similar banknote”) or the paper sheet is not similar to a banknote (hereinafter referred to as “dissimilar banknote”), and provides data to be referred to by the second judgment unit 114. These threshold values may be stored in the storage unit 110 beforehand, or may be written in the storage unit 110 based on an instruction of an operator received by the operation unit 103.

The control unit 111 is connected to the respective units 101 to 107, 109, 110 and 112 to 114 of the banknote handling system 100. Upon actuation of the control program 110A stored in the storage unit 110, the control unit 111 is configured to control the respective units 101 to 107, 109, 110 and 112 to 114 of the banknote handling system 100.

The reception unit 101 is configured to receive a pile of paper sheets set therein by an operator, and to take the pile of set paper sheets to an inside of the paper sheet handling system 100. The paper sheet herein includes not only a banknote but also a paper sheet (e.g., a barcode ticket and a coupon) other than a banknote.

The detection unit 112 is configured to detect a value (hereinafter referred to as “judgment parameter value”) of a judgment parameter (e.g., a parameter for judging denomination, a parameter for judging authenticity and a parameter for judging fitness) of a paper sheet received by the reception unit 101. For example, the detection unit 112 is formed of a red light line sensor, an infrared light line sensor, a magnetic sensor, an optical sensor and so on. The respective sensors are configured to detect the respective judgment parameter values regarding magnetic information of a paper sheet, a black and white ratio of the paper sheet, a size of the paper sheet, and so on. The judgment parameter values detected by the respective sensors are sent to the first and second judgment units 113 and 114 through the control unit 111.

The first judgment unit 113 is configured to judge whether a paper sheet received by the reception unit 101 is a predetermined banknote or not, based on a judgment parameter value detected by the detection unit 112 and the first judgment threshold value of the judgment standard 1108 stored in the storage unit 110. For example, the first judgment unit 113 performs the judgment process based on image information of the paper sheet, magnetic information of the paper sheet, a black and white ratio of the paper sheet, or a size of the paper sheet. When the judgment parameter value detected by the detection unit 112 is larger than the first judgment threshold value (e.g., when the detection result of the detection unit 112 is 95), the first judgment unit 113 judges the paper sheet received by the reception unit 101 as the “predetermined banknote”. Then, the first judgment unit 113 judges a property (e.g., denomination, direction, front or back, fit or unfit, or new or old) of the paper sheet, and counts the paper sheet.

The second judgment unit 114 is configured to judge whether a paper sheet that has not been judged as the “predetermined banknote” by the first judgment unit 113 is a dissimilar banknote or not, based on a judgment parameter value detected by the detection unit 112 and the second judgment threshold value of the judgment standard 1108 stored in the storage unit 110. For example, the second judgment unit 114 performs the judgment process based on image information of the paper sheet, magnetic information of the paper sheet, a black and white ratio of the banknote, or a size of the paper sheet. When the judgment parameter value detected by the detection unit 112 is smaller than the second judgment threshold value (e.g., when the detection result of the detection unit 112 is 50), the second judgment unit 114 judges the paper sheet received by the reception unit 101 as the “dissimilar banknote”. On the other hand, when the detection result of the detection unit 112 is larger than the second judgment threshold value and smaller than the first threshold value (e.g., when the detection result of the detection unit 112 is 80), the second judgment unit 114 judges the paper sheet received by the reception unit 101 as the “similar banknote”. Herein, the paper sheet judged as the “dissimilar banknote” is a paper sheet such as a barcode ticket and a coupon, which is not to be recounted. The paper sheet judged as the “similar banknote” is a paper sheet such as a banknote of undesignated denomination, which is to be recounted.

The first and second reject units 102A and 102B are configured to stack paper sheets that have not been judged as the “predetermined banknotes” by the first judgment unit 113 (i.e., paper sheets judged as the “dissimilar banknotes” and paper sheets judged as the “similar banknotes”). For example, paper sheets judged as the “dissimilar banknotes” by the second judgment unit 114 are put into the first reject unit 102A. On the other hand, paper sheets judged as the “similar banknotes” by the second judgment unit 114 are put into the second reject unit 102B. Each of the first and second reject units 102A and 102B is provided with a stopper composed of a pair of arms. The pair of arms include an upwardly extending first arm 108A whose lower end is pivotably supported, and a horizontally extending second arm 108B pivotably supported on a distal end of the first arm 108A. The first and second arms 108A and 108B are configured to stop and receive paper sheets discharged toward the first and second reject units 102A and 102B such that the paper sheets do not jump outside the paper sheet handling system 100. In order to make it easy for the paper sheets discharged to the first and second reject units 102A and 102B to be taken out, the first and second arms 108A and 108B are movable in two directions (an upward direction, and a rightward direction in which the reception unit 101 is disposed (opened)).

The first to fourth stacking units 106A to 106D are configured to sort paper sheets judged as the “predetermined banknotes” (i.e., banknotes) by the first judgment unit 113 depending on their properties and to stack the same. In order to make it easy for the banknotes discharged to the first to fourth stacking units 106A to 106D to be taken out, the first to fourth stacking units 106A to 106D are opened to the front. The first to fourth separate display units 107A to 107D are disposed above the first to fourth stacking units 106A to 106D, respectively. The first to fourth separate display units 107A to 107D are disposed correspondingly to the first to fourth stacking units 106A to 106D, and are configured to display the number of banknotes stacked in the corresponding first to fourth stacking units 106A to 106D.

The operation unit 103 has a plurality of input keys for receiving an instruction from an operator. For example, the operation unit 103 is configured to receive an instruction as to a recognition and count process mode regarding denomination of banknotes to be subjected to the recognition and count process, an instruction as to the first and second judgment threshold values of the judgment standard 1106 stored in the storage unit 110, an instruction as to start and stop of the recognition and count process, and an instruction as to confirmation of a count result.

The first and second entire display units 104 and 105 are configured to display predetermined information. For example, the first and second entire display units 104 and 105 display count results.

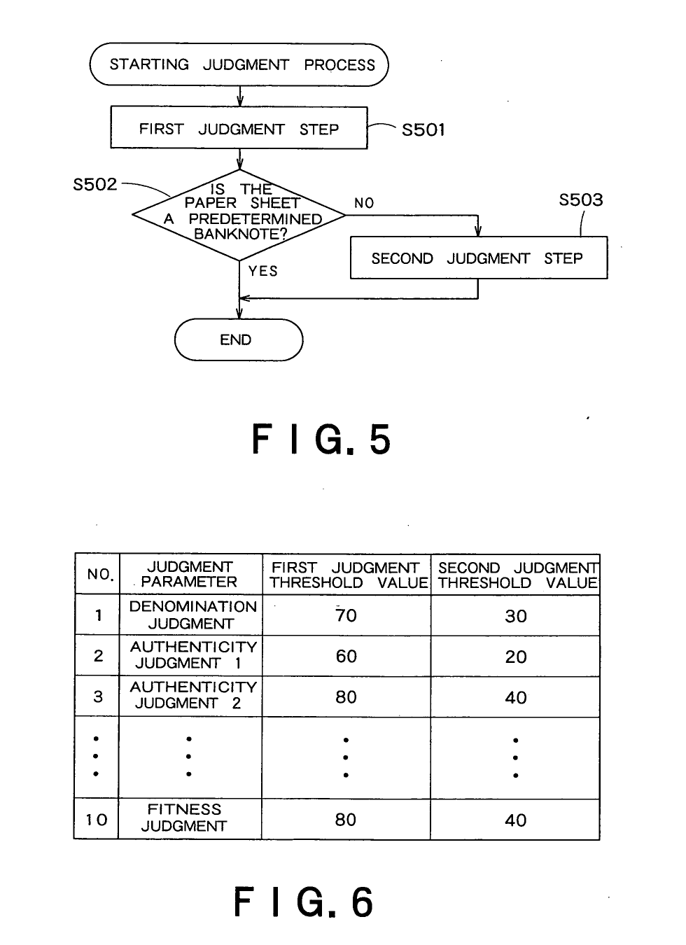

Next, process contents of the banknote handling system in the embodiment according to the present invention will be described with reference to FIGS. 4 and 5.

FIG. 4 is a flowchart showing a process procedure of a deposit process in the embodiment according to the present invention.

At first, the reception unit 101 starts a paper-sheet reception step for taking paper sheets to the inside of the banknote handling system 100 (S401). For example, when a start key of the operation unit 103 is pushed down, the paper-sheet reception step is started.

Then, a detection step (S402) is performed. In the detection step (S402), the detection unit 112 detects a judgment parameter value of each of the paper sheets received by the reception unit 101.

Then, a judgment process (S403) is performed (FIG. 5).

FIG. 5 is a flowchart showing a process procedure of the judgment process (S403) in the embodiment according to the present invention.

At first, a first judgment step (S501) is performed. In the first judgment step (S501), the first judgment unit 113 compares a judgment parameter value detected by the detection unit 112 with the first judgment threshold value of the judgment standard 110B stored in the storage unit 110, and judges whether the banknote received by the reception unit 101 is the predetermined banknote or not. Then, the first judgment unit 113 judges a property of the banknote, and counts the banknote. For example, the first judgment unit 113 judges a banknote as the “predetermined banknote” when the judgment parameter value detected by the detection unit 112 is larger than the first judgment threshold value.

Next, a paper sheet that was not judged as the “predetermined banknote” in the first judgment step (S501) (S502-NO) is subjected to a second judgment step (S503). In the second judgment step (S503), the second judgment unit 114 compares a judgment parameter value detected by the detection unit 112 with the second judgment threshold value of the judgment standard 110B stored in the storage unit 110, and judges whether the banknote received by the reception unit 101 is a dissimilar banknote or not. For example, when the judgment parameter value detected by the detection unit 112 is smaller than the second judgment threshold value, the second judgment unit 114 judges the banknote as the “dissimilar banknote”. On the other hand, when the judgment parameter value detected by the detection unit 112 is larger than the second judgment threshold value and smaller than the first judgment threshold value, the second judgment unit 114 judges the banknote as the “similar banknote”.

The judgment process (S403) in the embodiment according to the present invention is finished when a banknote is judged as the “predetermined banknote” in the first judgment step (S501) (S502-YES), or after the second judgment step (S503) has been performed.

After the judgment process (S403), a transport step (S404) is performed. In the transport step (S404), the transport unit 109 transports the paper sheet (banknote) which was judged as the “predetermined banknote” in the first judgment step (S501), to one of the first to fourth stacking units 106A to 106D, based on a property of the paper sheet. For example, the transport unit 109 transports the paper sheets (banknotes) that were judged as the “predetermined banknotes”, such that the paper sheets (banknotes) are sorted by denomination and put into the respective first to fourth stacking units 106A to 106D. In addition, the transport unit 109 transports a paper sheet which was judged as the “similar banknote” in the second judgment step (S503), to the second reject unit 102B, and a paper sheet which was judged as the “dissimilar banknote” in the second judgment step (S503), to the first reject unit 102A.

The detection step (S402) through the transport step (S404) are repeatedly performed until a stop requirement occurs (S405-NO). For example, the stop requirement occurs when there is no banknote anymore in the reception unit 101, when a stop instruction is received by the operation unit 103, or when the number of paper sheets stacked in the first to fourth stacking units 106A to 106D, the first reject unit 102A or the second reject unit 102B reaches a predetermined one.

When such a stop requirement occurs (S405-YES), the reception unit 101 stops the paper-sheet reception step (S406).

Then, a deposit confirmation step (S407) is performed. In the deposit confirmation step (S407), the control unit 111 displays count results for respective denominations of the paper sheets (banknotes) judged as the “predetermined banknotes” on the first or second entire display unit 104 or 105. When the count results are accepted (when an acceptance key of the operation unit 103 is pushed down, for example), the control unit 111 writes the count results as deposit data 110C in the storage unit 110.

The deposit process in the embodiment according to the present invention is finished after the deposit confirmation step (S407) has been performed.

In the embodiment according to the present invention, although the judgment parameter of the judgment standard 110B stored in the storage unit 110 is a parameter for judging denomination, by way of example, the present invention is not limited thereto. For example, the judgment parameter may be a parameter for judging fitness or a parameter for judging authenticity.

In addition, in the embodiment according to the present invention, when a paper sheet received by the reception unit 101 is abnormally transported (e.g., transferred in a skewed state, in an overlapped state, or in a chained state), the first judgment unit 113 may judge the paper sheet as an “abnormally transported banknote” in the first judgment step (S501). In this case, the second judgment step (S503) is omitted, and the transport unit 109 transports the paper sheet judged as the “abnormally transported banknote” to the second reject unit 102B, such that the paper sheet is to be recounted.

In addition, in the embodiment according to the present invention, when a paper sheet received by the reception unit 101 is a counterfeit note, the first judgment unit 113 may judge the paper sheet as a “counterfeit note” in the first judgment step (S501). In this case, the second judgment step (S503) is omitted, and the transport unit 109 transports the paper sheet judged as the “counterfeit note” to the first reject unit 102A, such that the paper sheet is not to be recounted.

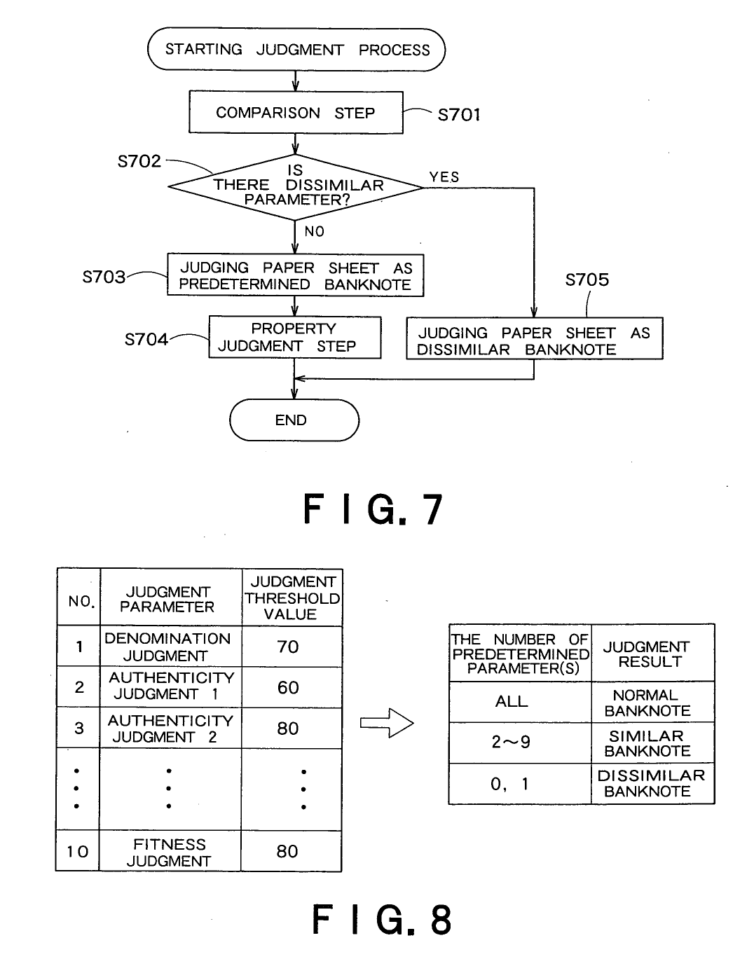

Next, an alternative example 1 of the embodiment according to the present invention will be described with reference to FIGS. 6 and 7. In the embodiment according to the present invention, the judgment processes in the first and second judgment steps are performed based on the comparative relationship between a judgment parameter value detected by the detection unit 112 and the first and second judgment threshold values, by way of example. Meanwhile, in the alternative example 1 of the embodiment according to the present invention, the second judgment step is performed based on an existence of a judgment parameter representing a dissimilar banknote (hereinafter referred to as “dissimilar parameter”). Description of the same process contents as those of the embodiment according to the present invention is omitted.

The storage unit 110 in the alternative example 1 of the embodiment according to the present invention stores a judgment standard 1108 as shown in FIG. 6. The judgment standard 110B is composed of a plurality of “judgment parameters”, and “first judgment threshold values” and “second judgment threshold values” corresponding to the respective judgment parameters. The plurality of “judgment parameters” are related to a judgment parameter value detected by the detection unit 112. For example, the judgment parameters include ten judgment parameters such as a parameter for judging denomination, a parameter for judging authenticity, a parameter for judging fitness, and so on.

FIG. 7 is a flowchart showing a process procedure of a judgment process (S403) in the alternative example 1 of the embodiment according to the present invention.

At first, a comparison step (S701) is performed. In the comparison step (S701), the first and second judgment units 113 and 114 compare a judgment parameter value detected by the detection unit 112 with the first and second judgment threshold values of the judgment standard 1106 stored in the storage unit 110. For example, when the judgment parameter value detected by the detection unit 112 is larger than the first judgment threshold value, the first judgment unit 113 judges the judgment parameter as a “judgment parameter representing a predetermined banknote (hereinafter referred to as “predetermined parameter”)”. When the judgment parameter value detected by the detection unit 112 is smaller than the second judgment threshold value, the second judgment unit 114 judges the judgment parameter as the “dissimilar parameter”.

In the comparison step (S701), when no judgment parameter judged as the “dissimilar parameter” is included in the plurality of judgment parameters (S702-NO), the first judgment unit 113 judges the paper sheet received by the reception unit 101 as a “predetermined banknote” (S703).

Then, a property judgment step (S704) is performed. In the property judgment step (S704), the first judgment unit 113 judges a property of each of the paper sheets (banknotes) judged as the “predetermined banknotes” in the step S703, and count the number of the paper sheets.

On the other hand, in the comparison step (S701), when a judgment parameter judged as the “dissimilar parameter” is included in the plurality of judgment parameters (S702-YES), the second judgment unit 114 judges the paper sheet received by the reception unit 101 as a “dissimilar banknote” (S705).

The judgment process (S403) in the alternative example 1 of the embodiment according to the present invention is finished after the property judgment step (S704) or the step S705 has been performed.

In the alternative example 1 of the embodiment according to the present invention, although the number of the judgment parameters is ten, the number of judgment parameters is not limited thereto. In addition, any judgment parameter is applicable as long as the judgment parameter represents a feature of a banknote.

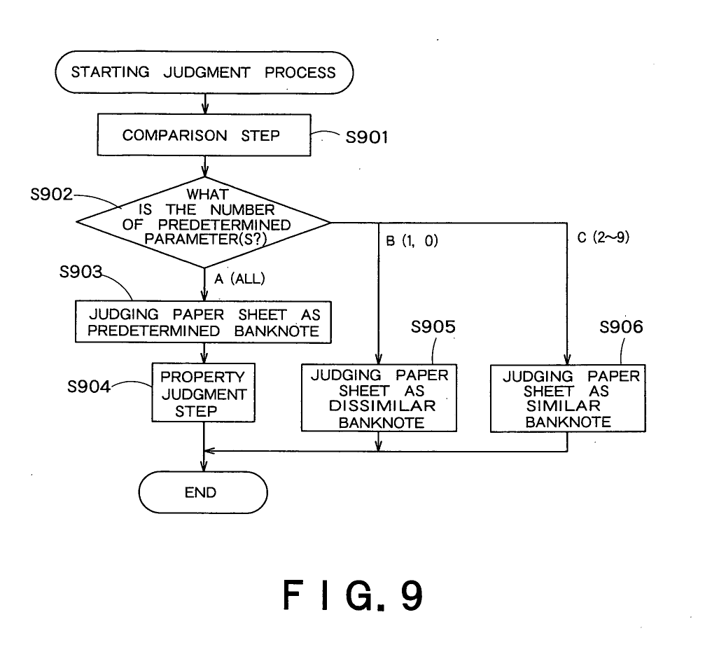

Next, an alternative example 2 of the embodiment according to the present invention will be described with reference to FIGS. 8 and 9. In the alternative example 1 of the embodiment according to the present invention, the second judgment step is performed based on the existence of a dissimilar parameter. Meanwhile, in the alternative example 2 of the embodiment according to the present invention, the first and second judgment processes are performed based on the number of predetermined parameter(s). Description of the same process contents as those of the embodiment according to the present invention is omitted.

The storage unit 110 stores a judgment standard 1106 as shown in FIG. 8. The judgment standard 1106 is composed of a plurality of “judgment parameters”, “judgment threshold values” corresponding to the respective judgment parameters, “the number of predetermined parameter(s)” and “judgment results” corresponding to the respective predetermined parameters. The plurality of “judgment parameters” are items of judgment parameter values detected by the detection unit 112. For example, the judgment parameters include ten judgment parameters such as a parameter for judging denomination, a parameter for judging authenticity, a parameter for judging fitness, and so on.

FIG. 9 is a flowchart showing a process procedure of a judgment process (S403) in the alternative example 2 of the embodiment according to the present invention.

At first, a comparison step (S901) is performed. In the comparison step (S901), the first judgment unit 113 compares a judgment parameter value detected by the detection unit 112 with the first judgment threshold value of the judgment standard 110B stored in the storage unit 110. For example, when the judgment parameter value detected by the detection unit 112 is larger than the first judgment threshold value, the first judgment unit 113 judges the judgment parameter as a “predetermined parameter”.

In the comparison step (S901), when all the judgment parameters are judged as the “predetermined parameters” (S902-A), the first judgment unit 113 judges the paper sheet received by the reception unit 101 as a “predetermined banknote” (S903).

Then, a property judgment step (S904) is performed. In the property judgment step (S904), the first judgment unit 113 judges a property of the paper sheet (banknote) judged as the “predetermined banknote” in the step S903, and count the paper sheet.

On the other hand, in the comparison step (S901), when “the number of predetermined parameter(s)” is one or less (S902-B), the second judgment unit 114 judges the paper sheet received by the reception unit 101 as a “dissimilar banknote” (S905).

On the other hand, in the comparison step (S901), when “the number of predetermined parameter(s)” is not less than two and not more than nine (S902-C), the second judgment unit 114 judges the paper sheet received by the reception unit 101 as a “similar banknote” (S906).

The judgment process (S403) in the alternative example 2 of the embodiment according to the present invention is finished after the property judgment step (S904), the step S905 or the step S906 has been performed.

In the alternative example 2 of the embodiment according to the present invention, although the number of the judgment parameters is ten, the number of judgment parameters is not limited thereto. In addition, any judgment parameter is applicable as long as the judgment parameter represents a feature of a banknote.

In the alternative example 2 of the embodiment according to the present invention, the second judgment unit 114 performs a judgment process based on the number of the predetermined parameters. However, the second judgment unit 114 may perform a judgment process based on a ratio of predetermined parameters relative to all the judgment parameters.

According to the embodiment of the present invention, the second judgment unit 114 judges whether a paper sheet which was not judged as the “predetermined banknote” is the dissimilar banknote or not. A paper sheet judged as the “dissimilar banknote” (a paper sheet not to be recounted) and a paper sheet judged as the “similar banknote” (a paper sheet to be recounted) are sorted and put into the first and second reject units 102A and 102B respectively. Thus, only the paper sheet to be recounted is put into the second reject unit 102B. As a result, an operation for extracting only the paper sheet to be recounted can be omitted, whereby the efficiency of the recognition and count process can be enhanced.

In addition, according to the embodiment of the present invention, whether a paper sheet is to be recounted or not to be recounted is judged with the use of the second judgment threshold value. Thus, it is not necessary to additionally provide a judgment unit for judging whether a banknote is the “dissimilar banknote” or the “similar banknote”, whereby a manufacturing cost of the banknote handling system 100 can be reduced.

1. A banknote handling system including at least one stacking unit and first and second reject units, the banknote handling system comprising:
a reception unit configured to receive a paper sheet;
a first judgment unit configured to judge whether the paper sheet received by the reception unit is a predetermined banknote or not;
a second judgment unit configured to judge whether the paper sheet that has not been judged as the predetermined banknote by the first judgment unit is a dissimilar banknote or not;
a transport unit configured to transport the paper sheet received by the reception unit to the stacking unit, the first reject unit, or the second reject unit; and
a control unit configured to control the transport unit such that: the paper sheet which has been judged as the predetermined banknote by the first judgment unit, is transported to the stacking unit; that the paper sheet which has been judged as the dissimilar banknote by the second judgment unit, is transported to the first reject unit; and that the paper sheet which has not been judged as the dissimilar banknote by the second judgment unit, is transported to the second reject unit.

2. The banknote handling system according to claim 1, wherein
when at least one judgment parameter among a plurality of judgment parameters of the paper sheet is a dissimilar parameter, the second judgment unit judges the paper sheet as a dissimilar banknote.

3. The banknote handling system according to claim 1, wherein
the second judgment unit performs the judgment process based on magnetic information of the paper sheet.

4. The banknote handling system according to claim 1, wherein
the second judgment unit performs the judgment process based on a black and white ratio of the paper sheet.

5. The banknote handling system according to claim 1, wherein
the second judgment unit performs the judgment process based on a size of the paper sheet.

6. The banknote handling system according to claim 1, wherein
the second judgment unit performs the judgment process based on the number or a ratio of dissimilar parameters among a plurality of judgment parameters.

7. The banknote handling system according to claim 1, wherein
the first judgment unit further judges whether the paper sheet is abnormally transported or not, and
the control unit controls the transport unit such that the paper sheet which has been judged as an abnormally transported banknote by the first judgment unit, is transported to the second reject unit.

8. The banknote handling system according to claim 1, wherein
the first judgment unit further judges whether the paper sheet is a counterfeit note or not, and
the control unit controls the transport unit such that the paper sheet which has been judged as a counterfeit note, is transported to the first reject unit.

9. The banknote handling system according to claim 1, wherein
the second judgment unit judges a paper sheet not to be recounted, as the dissimilar banknote.

10. The banknote handling system according to claim 1 further comprising a storage unit configured to store a judgment standard, and a detection unit configured to detect a feature of the paper sheet,
wherein, when a detection result of the detection unit deviates from a predetermined scope relative to the judgment standard stored in the storage unit, the second judgment unit judges the paper sheet as the dissimilar banknote.

11. A banknote handling method comprising:
receiving a paper sheet;
first judging whether the paper sheet received in the reception is a predetermined banknote or not;
second judging whether the paper sheet that has not been judged as the predetermined banknote in the first judging, is a dissimilar banknote or not; and
transporting in which the paper sheet that has been judged as the predetermined banknote in the first judging, the paper sheet that has been judged as the dissimilar banknote in the second judging, and the paper sheet that has not been judged as the dissimilar banknote in the second judging, are sorted and transported.
